(19) United States
(12) Patent Application Publication
(10) Pub. No.: US 2017/0326803 A1
(43) Pub. Date: Nov. 16, 2017

(54) Build Material Management Station

(71) Applicant: HEWLETT-PACKARD DEVELOPMENT COMPANY, L.P., Houston, TX (US)

(72) Inventors: Ismael Chanclon, Sant Cugat del Valles (ES); Xavier Alonso, Sant Cugat del Valles (ES); Ferran Esquius, Sant Cugat del Valles (ES); Marc Morros, Sant Cugat del Valles (ES); Marc Nicolau, Sant Cugat del Valles (ES)

(73) Assignee: HEWLETT-PACKARD DEVELOPMENT COMPANY, L.P., Houston, TX (US)

(21) Appl. No.: 15/591,792

(22) Filed: May 10, 2017

(30) Foreign Application Priority Data
May 12, 2016 (GB) 1608351.1

(51) Int. Cl. B29C 64/357; B33Y 40/00; B33Y 30/00; B29K 105/00

(52) U.S. Cl. CPC B29C 64/357; B33Y 30/00; B33Y 40/00; B29K 2105/251

(57) ABSTRACT

Examples provide a build material management station (106). The station comprises: a processing unit which comprises a first conduit (150a, 150b, 152a, 152b) and at least one pump for pumping build material through the first conduit; and at least one external build material storage tank (110, 114a, 114b). The processing unit further comprises at least a first port and a second port (154a, 154b), both ports being located on the exterior of the processing unit such that the external build material storage tank can be connected to the first conduit through the first port and the external build material storage tank can be connected to the first conduit through the second port

### BACKGROUND

Three dimensional printing is a widely used technique for the production of three dimensional (3D) components. Some 3D printing systems generate an object in 3D by forming a layer of a build material which at least partly comprises a powder and then selectively solidifying portions of the layer based on a cross section of an object being generated. By forming a plurality of such layers, complex 3D objects can be formed. Such a process produces the desired components, but those components are then typically surrounded by loose powder which was deposited but not fused during the printing process. It is often desirable to reclaim the loose powder for recycling, and for this purpose a material management station may be used.

### BRIEF DESCRIPTION OF THE DRAWINGS

Examples of a system will now be described by way of example with reference to the accompanying figures, in which:

FIG. 1A schematically illustrates an example of a three dimensional (3D) printing system;

FIG. 1B schematically illustrates the material management station of the example of FIG. 1A;

FIG. 1C schematically illustrates a working area of the material management station of the example of FIG. 1B;

FIG. 2 schematically illustrates an internal circuit diagram of a material management system; and

FIGS. 3A to 3J shows various configurations of a material management system.

### DETAILED DESCRIPTION

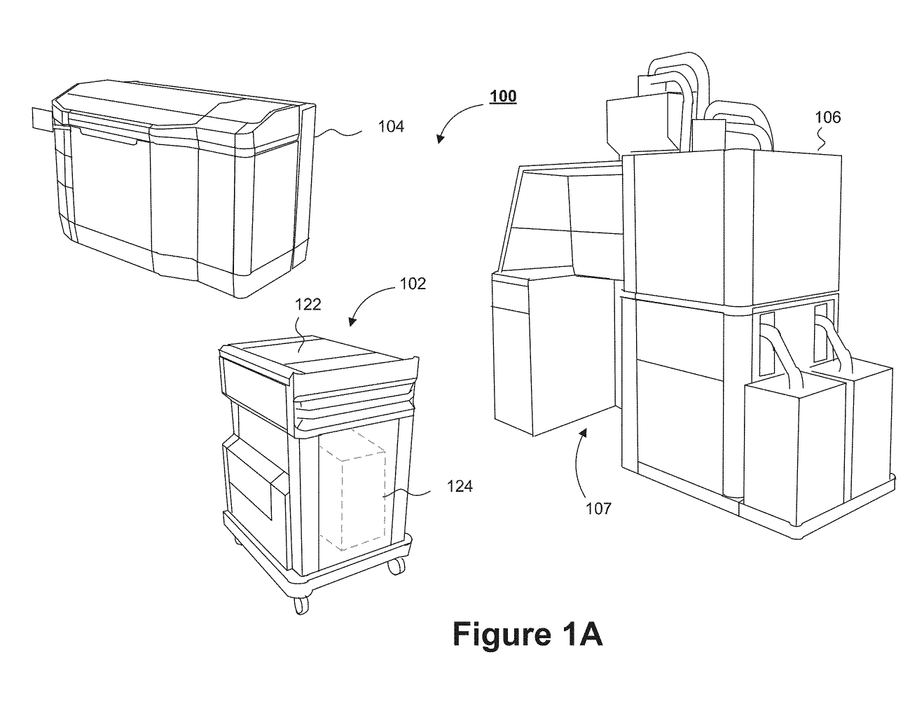

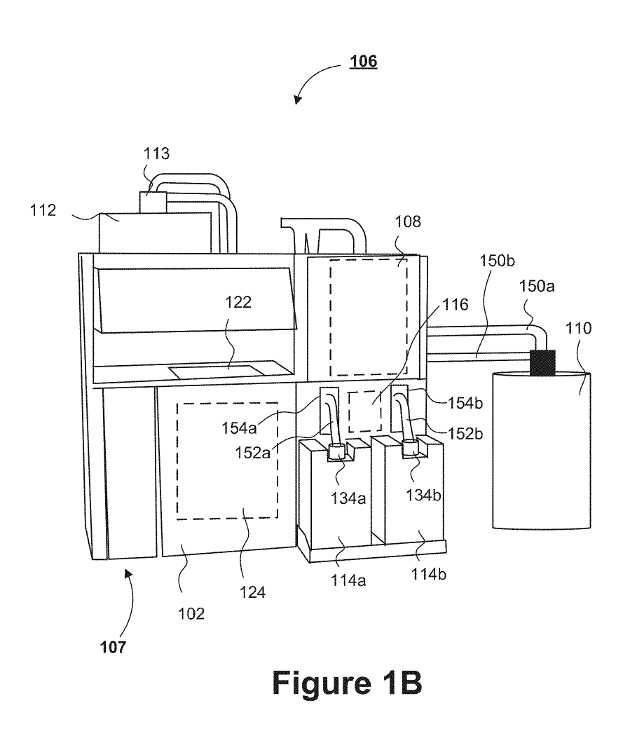

As shown in FIG. 1A, the 3D printing system 100 (or additive manufacturing system) according to one example comprises: a trolley 102, a 3D printer 104 and a material management station 106. The material management station 106 manages build material such as powder which is used by the 3D printing system.

The trolley 102 is arranged to slot into a docking position in the printer to allow the printer 104 to generate a 3D object within the trolley. The trolley is arranged to also slot (at a different time) into a docking position in the material management station 106. The trolley 102 may be docked in the material management station 106 prior to a 3D printing process to load the trolley with build material in preparation for a subsequent 3D printing process.

The build material loaded into the trolley may include recycled or recovered build material from one or more previous printing processes in preparation for a subsequent 3D printing process, fresh build material or a portion of fresh and recycled build material. Some build materials may be non-recyclable hence in this case no recovered build material will be used to load the trolley. The build material may be or include, for example, powdered metal materials, powdered composited materials, powder ceramic materials, powdered glass materials, powdered resin material, powdered polymer materials and the like. In some examples where the build material is a powder-based build material, the term powder-based materials is intended to encompass both dry and wet powder-based materials, particulate materials and granular materials. It should be understood that the examples described herein are not limited to powder-based materials, and may be used, with suitable modification if appropriate, with other suitable build materials. In other examples, the build material may be in the form of pellets, or any other suitable form of build material, for instance.

Returning to FIG. 1A, the trolley 102 may also be docked in the material management station 106 (shown without the trolley docked in FIG. 1A) to clean up at least some components of the trolley 102 after it has been used in a 3D printing production process. The clean-up process may involve recovery and storage in the material management station 106 of unfused build material from the previous print job for subsequent reuse. During a 3D printing process a portion of the supplied build material may be fused to form the 3D object, whilst a remaining portion of the supplied build material may remain unfused and potentially recyclable, depending upon the type of build material used. Some processing of the unfused build material may be performed by the material management station 106 prior to storage for recycling, to reduce any agglomeration for example.

One material management station 106 can be used to service one or more different 3D printers. A given 3D printer may interchangeably use one or more trolleys 102, for example, utilising different trolleys for different build materials. The material management station 106 can purge a trolley 102 of a given build material after a 3D printing production process, allowing it to be filled with a different build material for a subsequent 3D printing production run. Purging of the trolley 102 may also involve purging of the material management station 106 or alternatively, it may involve separation of different build materials in the material management station 106 to prevent contamination of one build material type with another.

FIG. 1B schematically illustrates the material management station 106 of the example of FIG. 1A, with the trolley 102 of FIG. 1A docked therein.

As shown in the example of FIG. 1B, the material management station 106 has two interfaces for receiving two fresh build material supply tanks (or cartridges) 114a, 114b, which may be releasably insertable in the material management station 106. In this example, each fresh build material supply tank 114a, 114b has a capacity of between about thirty and fifty litres. In one example, the build material may be a powdered semi-crystalline thermoplastic material. The provision of two fresh build material supply tanks 114a, 114b allows “hot swapping” to be performed such that if a currently active container becomes empty or close to empty of build material when the trolley 102 is being filled with build material by the material management station 106 in preparation for an additive manufacturing process, a fresh build material supply source can be dynamically changed to the other of the two tanks. The material management station 106 may have one or more weight measurement device(s) to assess how much fresh build material is present at a given time in one or more of the fresh build material supply tanks 114a, 114b. The fresh build material from the tanks 114a, 114b, may be consumed, for example, when loading the trolley 102 with build material prior to the trolley 102 being installed in the printer 104 for a 3D printing production run.

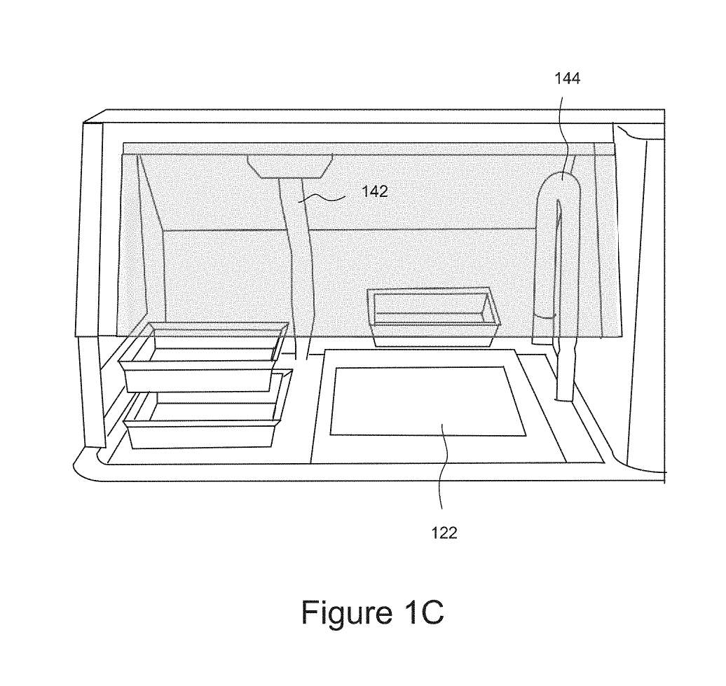

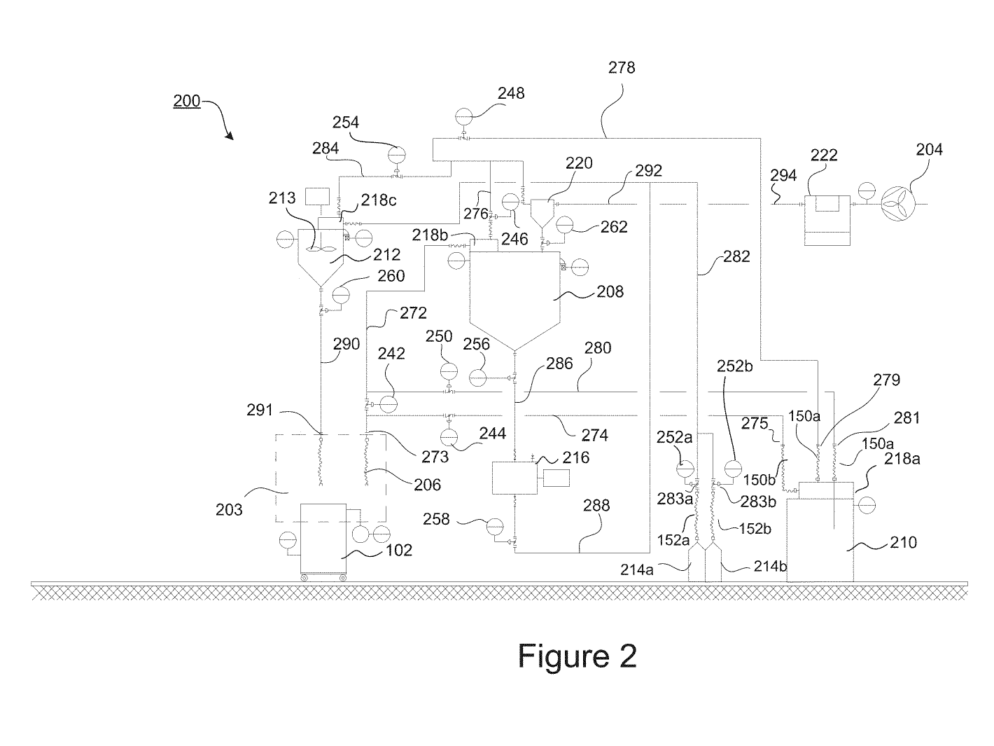

Build material is moved around within the material management station 106 in this example using a vacuum system (described below with reference to FIG. 2), which promotes cleanliness within the system and allows for recycling of at least a portion of build material between successive 3D printing jobs, where the type of build material selected for use is recyclable. References to a vacuum system in this specification include a vacuum that is partial vacuum or a pressure that is reduced, for example, relative to atmospheric pressure. The vacuum may correspond to “negative pressure”, which can be used to denote pressures below atmospheric pressure in a circuit surrounded by atmospheric pressure.

A total trolley-use time for printing of a 3D object before the printer 104 and/or the trolley 102 can be reused may depend upon both a printing time of the printer 104 when the trolley 102 is in the printer 104 and a cooling time of the contents of the build volume of the trolley 102. It will be understood that the trolley 102 can be removed from the printer 104 after the printing operation, allowing the printer 104 to be re-used for a further printing operation using build material within a different trolley before the total trolley-use time has elapsed. The trolley 102 can be moved to the material management station 106 at the end of the printing time. The vacuum system can be used, in some examples, to promote more rapid cooling of the contents of the build volume following a 3D print production process than would otherwise occur without the vacuum system. Alternatives examples to the vacuum system such as a compressed air system can create dust, potentially making the clean-up process more difficult.

The material management station 106 in this example has a recovered build material tank 108 (see FIG. 1B), located internally, where build material recovered from the trolley 102 by the vacuum system is stored for subsequent reuse, if appropriate. Some build materials may be recyclable whilst others may be non-recyclable. In an initial 3D printing production cycle, 100% fresh build material may be used. However, on second and subsequent printing cycles, depending upon build material characteristics and user choice, the build material used for the print job may comprise, in some examples, a proportion of fresh build material (e.g. 20%) and a portion of recycled build material (e.g. 80%). Some users may elect to use mainly or exclusively fresh build material on second and subsequent printing cycles, for example, considering safeguarding a quality of the printed object. The internal recovered build material tank 108 may become full during a post-production clean-up process, although it may become full after two or more post-production clean up processes, but not before. Accordingly, an overflow tank in the form of an external overflow tank 110 is provided as part of the material management station 106 to provide additional capacity for recovered build material for use once the internal recovered build material tank 108 is full or close to full capacity. Alternatively, the external overflow tank 110 can be a removable tank. In this example, one or more ports are provided as part of the material management station 106 to allow for output or reception of build material to and/or from the external overflow tank 110. The external overflow tank is connected to the rest of the material management station 106 by two first hoses 150a, 150b. A sieve 116 or alternative build material refinement device may be provided for use together with the internal recovered build material tank 108 to make unfused build material recovered from a 3D printing production process for recycling more granular, that is, to reduce agglomeration (clumping).

The material management station 106 in this example has a mixing tank (or blending tank) 112 comprising a mixing blade (not shown) for mixing recovered build material from the internal recovered build material tank 108 with fresh build material from one of the fresh build material supply tanks 114a, 114b for supply to the trolley 102 when it is loaded prior to a printing production process. The mixing tank (or blending tank) 112, in this example, is provided on top of the material management station 106, above the location of the build platform 122 when the trolley 102 is docked therein. The mixing tank 112 is connected to a mixer build material trap 113 for input of build material into the mixing tank 112.

The fresh build material supply tanks 114a, 114b may be releasably connected to the main body of the material management station 106. The material management station comprises two second hoses 152a, 152b which are fed through respective ports 154a 154b, and comprise respective supply tank connectors 134a, 134b for connecting to the respective supply tanks 114a, 114b. These supply tank connectors 134a, 134b may incorporate a security system to reduce the likelihood of unsuitable build material being used in the 3D printing system. In one example, suitable fresh build material supply tanks 114a, 114b are provided with a secure memory chip, which can be read by a chip reader (not shown) or other processing circuitry on the main body of the material management station 106 to verify the authenticity of any replacement supply tank (cartridge) 114a, 114b that has been installed. In this example, the chip reader may be provided on the supply tank connectors 134a, 134b and upon attachment of the fresh build material supply tanks 114a, 114b to the respective connector 134a, 134b, an electrical connection may be formed. The processing circuitry in the material management station 106 may also be used to write a measured weight of build material determined to be in the respective fresh build material supply tank(s) 114a, 114b onto the secure memory chip of the tank to store and/or update that value. Thus, the amount of authorised build material remaining in the fresh build material supply tank(s) 114a, 114b at the end of a trolley loading process can be recorded. This allows the withdrawal of particulate build material from the fresh build material supply tanks 114a, 114b beyond the quantity with which it was filled by the manufacturer to be prevented. For example, in the case of a fresh build material supply tank 114a, 114b from which the tank manufacturer's authorised fresh build material has previously been completely withdrawn, this prevents the withdrawal of further build material that may damage the printer or print quality, if the fresh build material supply tank were re-filled with alternative fresh build material.

The secure memory chip of the fresh build material supply tanks 114a, 114b can store a material type of the build material contained within the fresh build material supply tanks. In one example, the material type the material (e.g. ceramic, glass, resin etc.). In this way, the material management station 106 can determine the material type to be used by the material management station 106.

FIG. 1C schematically illustrates a working area of the material management station 106 of the example of FIG. 1B, showing the build platform 122 of the trolley 102 and a build material loading hose 142, which provides a path between the mixing tank 112 of FIG. 1B and the build material store 124 of the trolley 102. The loading hose 142 is used for loading the trolley 102 with build material prior to the trolley 102 being used in the printer 104. FIG. 1C also shows a recycling hose 144 for unpacking manufactured objects, cleaning the build platform 122 of the trolley 102 and a surrounding working area within the material management station 106. In one example, the recycling hose 144 operates by suction provided via a pump 204 (see FIG. 2) and provides an enclosed path to the recovered build material tank 108 (see FIG. 1B) for receiving and holding build material for re-use in a subsequent 3D printing process. The recycling hose 144 may, in one example, be operated manually by a user to recover recyclable build material from and/or to clean up a working area of the material management station 106.

FIG. 2 schematically illustrates an internal circuit diagram of one example of a build material management system in the form of a material management station 106. The material management station 106 can be used in conjunction with the trolley 102 of FIG. 1A.

As previously described, printed parts along with unfused build material can be transported from the 3D printer 104 to the material management station 106 via the trolley 102. The material management station 106 can then be used to process build material and printed parts from the trolley 102.

In another example, printed parts along with unfused build material can be transported from the 3D printer 104 to the material management station 106 via another suitable container, e.g. a box or cartridge (not shown) instead of the trolley 102. The material management station 106 may then be used to process the powder-based material and printed parts from the container.

The material management station circuit 200 includes a conduit (or guide-channel) network and a pump 204 to provide pressure differential across the conduit network to transport unfused build materials between different components, as described below with reference to FIG. 2. In this example, the pump 204 is a suction pump which operates to create a pressure differential across the suction pump to produce air flow from an air inlet at substantially atmospheric pressure through the conduit network towards an upstream side of the suction pump (at a pressure below atmospheric pressure or at “negative pressure”). The pump 204 may be provided as an integral part of the material management station 106 in one example, but in another example, the material management station 106 provides a negative/reduced pressure interface, via which a suction pump may be detachably coupled or coupled in a fixed configuration. Although the description below refers to first conduit, second conduit, third conduit etc. of the conduit network, there is no implied ordering in the number of the conduits other than to distinguish one conduit from another.

A collection hose 206 is connected to a recovered build material tank (RBMT) 208 via a working area port in a working area 203 in the form of a working area inlet port 273 and a first conduit (hose-to-RBMT conduit) 272 of the conduit network. The recovered build material tank 208 includes a recovered build material tank (RBMT) inlet area comprising a recovered build material tank (RBMT) build material trap 218b and a recovered build material tank (RBMT) material outlet. The RBMT inlet area is where a fluidised flow of build material is received for storage in the recovered build material tank 208. The first conduit 272 provides a path between the working area inlet port 273 and the RBMT inlet area. The working area inlet port 273 is to receive build material from the collection hose 206 and is provided at an end of the first conduit 272 connected to the collection hose 206. In other examples, the RBMT inlet area may communicate directly with the working area 203 or the collection hose 206 without a first conduit 272 between.

The recovered build material tank 208 in this example is provided internally to the material management station 106. A hose-to-RBMT valve 242 is positioned along the first conduit 272 for opening and closing the path through the first conduit 272. The collection hose 206 extends from the working area inlet port 273 into the working area 203. The working area 203 includes at least a portion of the trolley 102 (or other container) and can be maintained at substantially atmospheric pressure. Build material from the trolley 102 can be collected by the collection hose 206 and transported to the recovered build material tank 208 through the first conduit 272. The recovered build material tank 208 can be used for storing any unfused build material from the trolley 102 that is suitable for being used again in a further 3D printing (additive manufacturing) process. In this way, the recovered build material tank 208 can be used as a buffer storage tank to temporarily store unfused build material prior to supplying the unfused build material for use in a further 3D printing (additive manufacturing) process.

A second conduit 274 (hose-to-overflow conduit) of the conduit network connects the collection hose 206 to an overflow tank 210. The overflow tank 210 includes an overflow inlet area and the second conduit 274 provides a path between the collection hose 206 and the overflow inlet area comprising, in this example, an overflow built material trap 218a (a filter). An overflow tank port in the form of an overflow tank outlet port 275 may also be provided at an end of the second conduit 274. The overflow tank 210 can be selectively sealed by an openable lid (not shown). In a sealed configuration, the overflow tank 210 is in fluid communication with one or more overflow inlet ports and overflow outlet ports of the conduit network. Furthermore, in the sealed configuration, the overflow tank 210 is not directly open to atmosphere. Build material from the working area 203 can be transported through the second conduit 274 and overflow tank outlet port 275 into the overflow tank 210. A hose-to-overflow valve 244 is positioned along the second conduit 274 for opening and closing a path through the second conduit 274. Unfused build material from the trolley 102 (or other container) can be collected by the collection hose 206 and transported to the overflow tank 210 through the first conduit 272. The overflow tank 210 is an external tank that is removable and that can be used for storing excess recovered (recyclable) build material when the recovered build material tank 208 is full. Alternatively, the overflow tank 210 can be used as a waste storage tank to store unfused build material from the trolley 102 that is not suitable for recycling. In a further alternative, the overflow tank 210 can be used as a purged build material storage tank to store unfused build material from the trolley 102 and from elsewhere in the material management station 106 when the material management station 106 is purged of unfused build material.

The pump 204 is connected via a third conduit (pump-to-RBMT conduit) 276 of the conduit network to the recovered build material tank 208. The third conduit 276 provides a path between the pump 204 and the RBMT inlet area. A RBMT-to-pump valve 246 is positioned along the third conduit 276 for opening and closing the path through the third conduit 276.

The pump 204 is also connected to the overflow tank 210 via a fourth conduit (pump-to-overflow) 278 of the conduit network. The fourth conduit 278 provides a path between the pump 204 and the overflow inlet area. An overflow tank port in the form of an overflow tank vacuum port 279 may also be provided at an end of the fourth conduit 278. Fluid, e.g. air, can transmit through the overflow tank vacuum port 279 from the overflow inlet area towards the pump 204. An overflow-to-pump valve 248 is positioned along the fourth conduit 278 for opening and closing a path through the fourth conduit 278.

Unfused build material in the trolley 102 can be collected using the collection hose 206 and transported either to the recovered build material tank 208 or to the overflow tank 210, or both. The tank to be used at a given time can be selected by opening appropriate valves along the conduits of the circuit of FIG. 2.

In an example, a recyclability indicator is determined by processing circuitry of the build material management station 106. The recyclability indicator can be indicative of whether the build material in the trolley 102 (or container) includes recyclable or recoverable material. When it is determined that the unfused build material in the trolley 102 is not recyclable or when the recovered build material tank 208 is full, the unfused build material can be transported to the overflow tank 210.

To transport the unfused build material from the trolley 102 to the overflow tank 210, the hose-to-overflow valve 244 in the second conduit 274 between the collection hose 206 and the overflow tank 210 and the overflow-to-pump valve 248 in the fourth conduit 278 between the pump 204 and the overflow tank 210 can be opened. When the pump is active, a differential pressure is provided from the pump to the collection hose 206. That is, a pressure at the pump 204 is lower than a pressure at the collection hose 206. The differential pressure enables build material from the trolley 102 (or container) to be transported to the overflow tank 210. Build material (and air) in proximity with an end of the collection hose 206 (at approximately atmospheric pressure) is transported from the collection hose 206. along the second conduit 274 and through the hose-to-overflow valve 244 to overflow tank 210. The overflow tank 210 is provided in the sealed configuration. At the overflow tank 210, build material separates from air flow and drops from the overflow inlet area into the overflow tank 210. Air (and any residual build material) continues along the fourth conduit 278 and through the overflow-to-pump valve 248 towards the pump 204, which is at a reduced pressure.

To help prevent unfused build material traveling through the overflow inlet area of the overflow tank 210 into the fourth conduit 278 towards the pump 204, the overflow inlet area can include an overflow build material trap 218a (e.g. a powder trap). The overflow build material trap 218a is arranged to collect build material from the second conduit 274 and divert the build material (e.g. powder) into the overflow tank 210. Thus, the overflow build material trap 218a helps prevent build material conveying past the overflow inlet area of the overflow tank 210 and entering the fourth conduit 278 via the overflow tank vacuum port 279 to travel towards the pump 204.

The overflow build material trap 218a may include a filter (e.g. a mesh), which collects build material transported from the overflow tank 210. Thus, the filter separates build material from air flow in the overflow inlet area. Holes in the filter are small enough to prevent the passage of at least 95% of build material but allow relatively free flow of air through the filter. Holes in the filter may be small enough to prevent the passage of at least 99% of build material, whilst still allowing relatively free flow of air through the filter. Build material collected by the filter may drop from the overflow inlet area into the overflow tank 210.

The recovered build material tank 208 is also connected via a fifth conduit (overflow-to-RBMT conduit) 280 of the conduit network. An overflow tank port in the form of an overflow tank inlet port 281 may also be provided at an end of the fifth conduit 280. Build material from the overflow tank 210 can be transported through the fifth conduit 280 and overflow tank inlet port 281 into the recovered build material tank 208.

The fifth conduit 280 between the recovered material tank 208 and the overflow tank inlet port 281 includes an overflow-to-RBMT valve 250 in the path leading to the RBMT build material trap. In the event that the recovered build material tank 208 needs to be refilled with recovered build material, the overflow-to-RMBT valve 250 in the fifth conduit 280 between the recovered build material tank 208 and the overflow tank 210 can be opened, along with the RBMT-to-pump valve 246 in the third conduit 276 between the recovered build material tank 208 and the pump 204. When the pump is active, a differential pressure is provided from the pump to the overflow tank 210. That is, a pressure at the pump 204 is lower than a pressure at the overflow tank 210. In this example, the overflow tank 210 is provided in an unsealed configuration and includes an air inlet (not shown) open to atmosphere to maintain approximately atmospheric pressure within the overflow tank 210. The differential pressure enables build material from the overflow tank 210 to be transported to the recovered build material tank 208. Air flows into the overflow tank 210 through the air inlet. Build material (and air) in the overflow tank is transported from the overflow tank 210, along the fifth conduit 280 and through the overflow-to-RMBT valve 25042 to the recovered build material tank 208. At the recovered build material tank 208, build material separates from air flow and drops from the RBMT inlet area into the recovered build material tank 208. Air (and any residual build material) continues along the third conduit 276 and through the RBMT-to-pump valve 246 towards the pump 204, which is at a reduced pressure.

The material management station circuit 200 also includes a mixing tank 212. The mixing tank 212 can be used to mix recovered build material from the recovered build material tank 208 with fresh build material from a fresh build material supply tank 214a or 214b, ready to be used in a 3D printing process.

Although two fresh build material supply tanks 214a, 214b are shown in this example, in other examples, one or more fresh build material supply tanks 214a, 214b may be used. More fresh build material supply tanks 214a, 214b may be used when appropriate.

Each fresh build material supply tank 214a, 214b is connected to the mixing tank 212 via a sixth conduit (a fresh build material conduit) 282 of the conduit network, a fresh build material supply tank port 283a, 283b and a hose 152a, 152b. The fresh build material supply tank port 283a, 283b is to output build material from the respective fresh build material supply tank 214a, 214b. Each fresh build material supply tank 214a, 214b has an associated material supply tank cartridge-to-mixer valve 252a, 252b in the sixth conduit 282 between the respective fresh build material supply tank 214a, 214b and the mixing tank 212. Each fresh build material supply tank 214a, 214b also includes an air inlet valve whereby to ensure air can enter the fresh build material supply tanks 214a, 214b to maintain air pressure within the fresh build material supply tanks 214a, 214b at approximately atmospheric pressure.

The mixing tank 212 is connected via a seventh conduit 284 of the conduit network to the pump 204. The seventh conduit 284 between the mixing tank 212 and the pump 204 includes a mixer-to-pump valve 254, which may be opened or closed to open and close the passage through the seventh conduit 284.

To transport fresh build material from the fresh build material supply tank 214a or 214b to the mixing tank 212, the material supply tank cartridge-to-mixer valve 252a or 252b and the mixer-to-pump valve 254 in the seventh conduit 284 between the mixing tank 212 and the pump 204 are opened. When the pump 204 is active, a differential pressure is provided from the pump 204 to the fresh build material supply tank 214a or 214b. That is, a pressure at the pump 204 is lower than a pressure at the fresh build material supply tank 214a or 214b. The differential pressure enables build material from the fresh build material supply tank 214a or 214b to be transported to the mixing tank 212. Build material (and air) in the fresh build material supply tank 214a or 214b is transported from the fresh build material supply tank 214a or 214b, along the sixth conduit 282 and through the cartridge-to-mixer valve 252a or 252b to the mixing tank 212. At the mixing tank 212, build material separates from air flow and drops from the mixer inlet area into the mixing tank 212. Air (and any residual build material) continues along the seventh conduit 284 and through the mixer-to-pump valve 254 towards the pump 204, which is at a reduced pressure.

The mixer inlet area of the mixing tank 212 can also include a mixer build material trap 218c (e.g. a powder trap) or any type of mixer build material filter to separate an air flow from a build material flow, which operates in the same or similar manner to as the overflow build material trap 218a and the RBMT build material trap 218b. The mixer build material trap 218c helps to collect and divert build material into the mixing tank 212, and help prevent the build material from travelling through the seventh conduit 284 towards the pump 204.

The mixing tank 212 is also connected to the recovered build material tank 208 via an eighth conduit (RBMT-to-mixer conduit) 286 of the conduit network and a ninth conduit 288 of the conduit network extending sequentially from the recovered build material tank 208 to the mixing tank 212. The ninth conduit 288 may be part of the RBMT-to-mixer conduit 286.

A currently selected ratio of recycled build material from the recyclable build material tank 208 and fresh build material from the fresh build material supply tank 214a or 214b can be transported to the mixing tank 212 as described above. The ratio of fresh build material to recovered build material may be any selected ratio. The ratio may depend on the type of build material and/or the type of additive manufacturing process. In a selective laser sintering process the ratio could be, for example 50% fresh to 50% recovered build material. In one example of a printhead cartridge 3D printing process, the ratio may be 80% recovered to 20% fresh build material. For some build materials 100% fresh build material may be used, but for other build materials up to 100% recovered build material may be used. The fresh build material and the recycled build material can then be mixed together within the mixing tank 212 using, for example, a rotating mixing blade 213.

Once the fresh build material and the recovered build material are sufficiently mixed, the mixed build material can be transported from the mixing tank 212 through a mixer-to-trolley valve 260, a tenth conduit (mixer-to-trolley conduit) 290 of the conduit network, a working area port in the form of a working area outlet port 291, to the working area 203 and into the trolley 102. Build material from the mixing tank 212 can pass through the working area outlet port 291 into the working area 203. The trolley 102 (or container) can be located substantially beneath the mixing tank 212 so that gravity can aid the transport of mixed build material from the mixing tank 212, through the mixer-to-trolley valve 260, the tenth conduit 290, the working area outlet port 291 and the working area 203 to the trolley 102.

Once the trolley 102 is filled with enough build material for a given 3D print run, the trolley 102 can be returned to the 3D printer. An appropriate quantity of build material to fill the trolley 1202 for a print job may be controlled by the controller 295 of the material management station 106 based on the material management station 106 sensing how much build material is in the trolley when the trolley is docked in the material management station 106 at the beginning of a trolley fill workflow. The controller may then fill the trolley with a particular quantity (dose) of build material requested by a user for a particular print job intended by the user. The dosing is achieved by using a fill level sensor (not shown) such as a load cell in the mixing tank 212 to output a fill level value indicative of an amount of non-fused build material in the mixing tank. The fill level sensor can be one or more load cells, or any other type of sensor such as a laser-based sensor, a microwave sensor, a radar, a sonar, a capacitive sensor, etc. When the fill level sensor is a load cell, the fill level value can be an electrical signal indicative of a mass of the non-fused build material in the storage container.

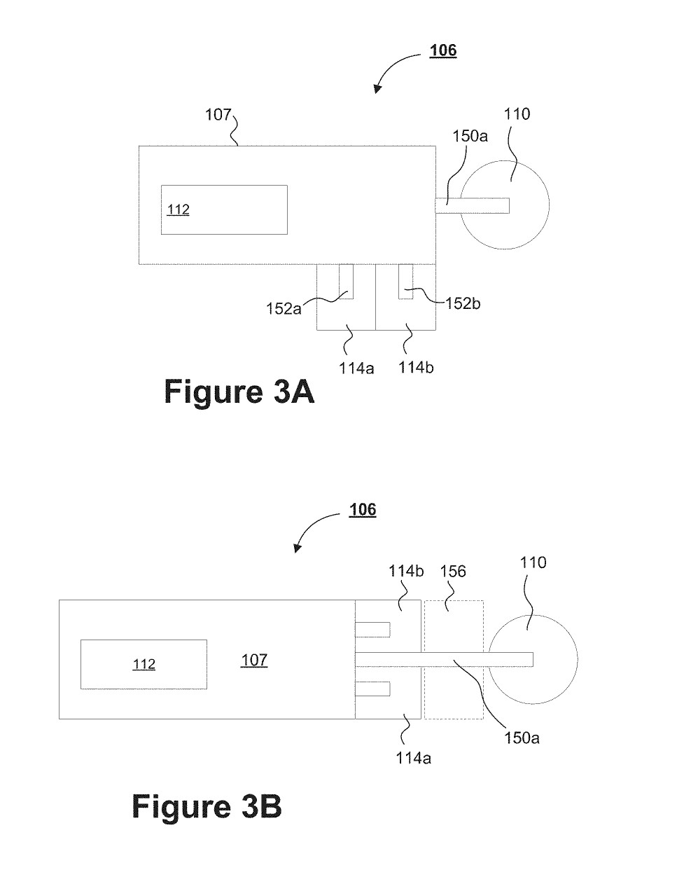

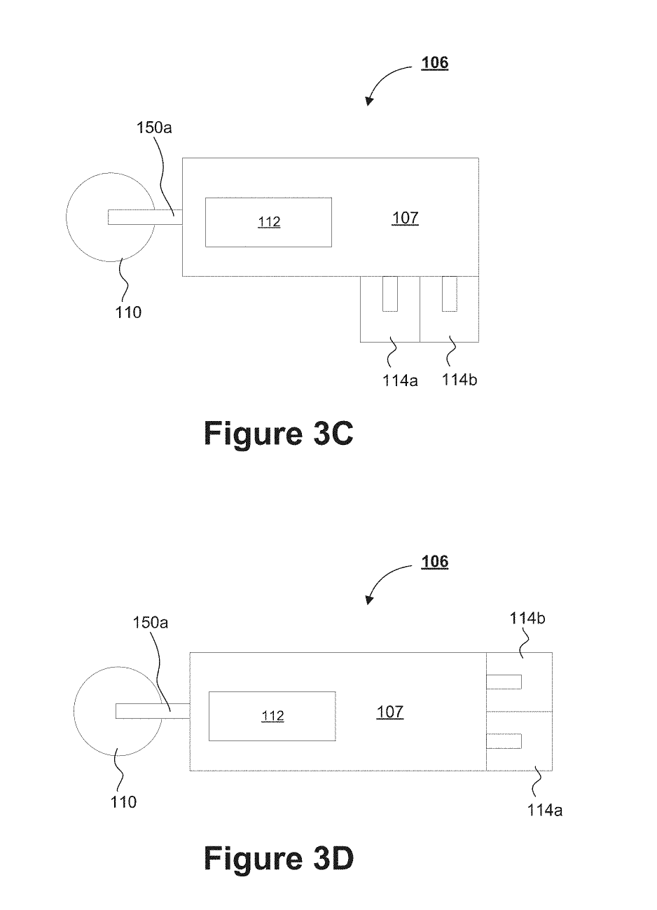

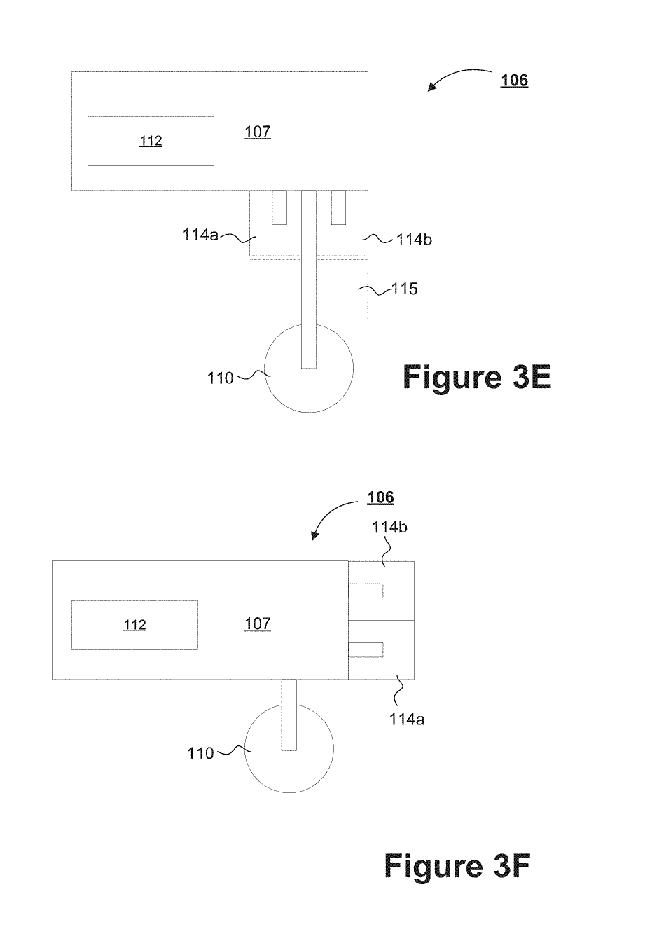

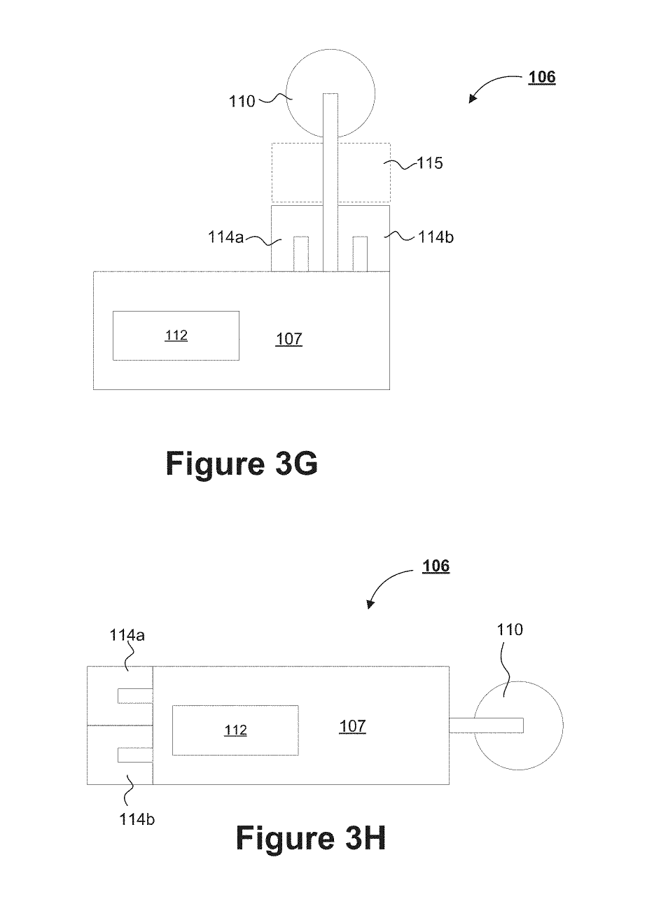

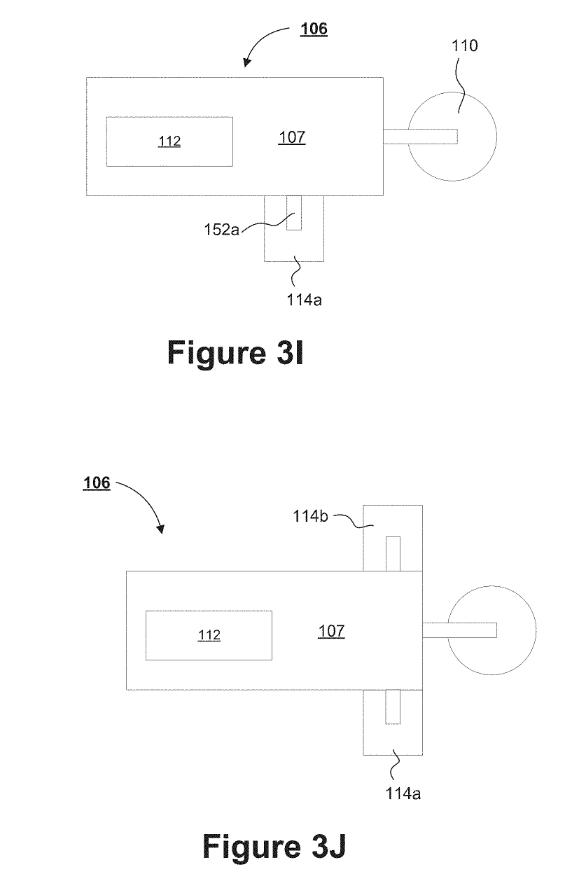

FIG. 3A shows the material management station 106 from a plan view, with the tanks 110, 114a, 114b arranged in the same configuration as shown in FIG. 1B. As is described above, the external tanks 114a, 114b, 110 are connected to the processing unit 107 of the material management station 106 by hoses 150a, 150b, 152a, 152b, although from a plan view 150b is hidden underneath 150a. The first hoses 150a, 150b are connected to the second conduit 274, the fourth conduit 278 or the fifth conduit 280, while the second hoses 152a and 152b are both connected to the sixth conduit 282 as shown in FIG. 2. The overflow tank 110 and the fresh build material supply tanks 114a, 114b are therefore both located outside the processing unit 107 and can be disconnected from the hoses and replaced as desired. As can be seen from FIG. 3A, the processing unit 107 and the fresh build material supply tanks 114a, 114b all have a substantially rectangular footprint. The overflow tank 110 can also have a substantially rectangular footprint if one is desired by the user.

The fresh build material supply tanks 114a, 114b, the external overflow tank 110 and the processing unit 107 of the material management station 106 are constructed to fit together in a modular way, permitting a number of alternative configurations for the fully assembled material management station 106, thus making the material management station 106 adaptable to fit into different housing spaces in a manufacturing environment.

In order to support this function the exterior of the processing unit 107 of the material management station 106 is provided with a plurality of ports such as the ports 154a 154b shown in FIG. 2B. Each port can be releasably sealed in order to protect the interior of the processing unit when the port is not in use. The hoses 150a, 150b, 152a, 152b are flexible such that they can be moved from one port to the other as desired. As such, the material management station 106 can be put into a number of different configurations without the need for further components to be added. The hoses 150a, 150b, 152a, 152b can be directed to any port and then connected to a tank as required. If it is useful, extension hoses can be fitted to the first and second hoses to extend their reach as desired.

For example, FIG. 3B shows a configuration of a material management station 106 in which the second hoses 152a, 152b have been redirected to ports on the right hand side of the processing unit 106 in the plan view shown in the diagram. As such, the fresh build material supply tanks 114a, 114b are also located on the right hand side of the machine, beneath the second hoses 150a, 150b which are still connected to the external overflow tank 110. A space 156 has been left between the fresh build material supply tanks 114a, 114b and the external overflow tank 110 in order to allow easy access to the fresh build material supply tanks 114a, 114b for maintenance and replacement. In order to provide this space, the first hoses 150a, 150b extend further out of the processing unit 107.

Many other configurations of the material management station 106 are possible. FIGS. 3C and 3D show configurations in which the first hoses 150a, 150b have been redirected to ports on the left hand side of the machine in the plan view shown in the diagram. The external overflow tank 110 is hence located adjacent to the space provided within the processing unit 107 for the trolley 102.

FIG. 3E shows a configuration in which both the first hoses 150a, 150b and the second hoses 152a, 152b have been directed to ports on the front of the processing unit 106, that is to say the below the processing unit in the plan view shown in the diagram. Here again, the first hoses 150a, 150b have been extended in order to provide space 115 for easy access to the fresh build material supply tanks 114a, 114b.

FIG. 3F shows a configuration in which the second hoses 152a, 152b are directed to ports on the right of the processing unit, while the first hoses 150a. 150b have been shortened in order to bring the external overflow tank 110 closer to the processing unit 107.

FIG. 3G shows a configuration in which the first hoses 150a, 150b and the second hoses 152a, 152b have been directed to ports on the rear of the processing unit 106, above the processing unit in the plan view shown in the diagram. Hoses 150a, 150b have here also been extended in order to provide space 115 for easy access to the fresh build material supply tanks 114a, 114b.

FIG. 3H shows a configuration in which the first hoses 150a, 150b are located to the right of the processing unit 107, while the second hoses 152a, 152b are located to the left of the processing unit.

While the provision of two fresh build material supply tanks 114a, 114b allows for hot swapping as shown above, they are not necessary for the processing unit 107 to function. FIG. 3I shows a configuration in which one second hose 152a is directed through a port on the processing unit 107 and connected to a single fresh build material supply tank 114a. It is also possible to provide a plurality of external overflow tanks 110 if this is desired, for example to increase the available overflow capacity.

The fresh build material supply tanks also do not need to be located adjacent with each other. FIG. 3J shows an example in which the second hoses 150a, 150b are directed to ports on opposite sides of the processing unit 107.

As part of an installation process of a material management system 106, a user can choose a suitable configuration of the processing unit 106, external overflow tank 110 and fresh build material supply tanks 114a, 114b according to their requirements. Other configurations of the material management system 106 than those shown in FIG. 3 are possible; for example additional ports can be provided almost anywhere on the surface of the processing unit 107 provided that they do not interfere with its other functions. These additional ports allow the placement of tanks in a wide variety of positions relative to the processing unit 107. Once a configuration is decided upon and ports are provided as desired, the hoses 150a, 150b, 152a. 152b are directed to the desired ports, and any excess ports are sealed in order to protect the interior of the processing unit 107. The external overflow tank 110 and fresh build material supply tanks 114a, 114b are then attached.

In an alternative example of a processing unit, the fourth, fifth and sixth conduits 278, 280, 282 may comprise a branching structure, such that each conduit may be connected to a plurality of ports on the processing unit. Each port may then be provided with a hose attachment for connecting the port to an external overflow tank 110 or a fresh build material supply tank 114a, 114b. Each port may alternatively be sealed when not in use. The fourth, fifth and sixth conduits 278, 280, 282 may further comprise additional valves for sealing a branch of the conduit when it is not in use, for example because the port is sealed.

A processing unit as described above may comprise a retaining member to retain the external tanks 114a, 114b, 110 in a position relative to the processing unit 107. A retaining member may comprise a latch, lock, strap or any other item or mechanism which is suitable to hold an external tank 114a, 114b, 110 in a desired location relative to the ports on the processing unit. The retaining member may also comprise a supporting member, such as a shelf or tray on which the external tank 114a, 114b, 110 rests.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

The disclosure herein is not restricted to the details of any foregoing examples. The disclosure also extends to any novel one, or any novel combination, of the features disclosed in this specification (including any accompanying claims, abstract and drawings), or to any novel one, or any novel combination, of the parts of any method or process so disclosed. The claims should not be construed to cover merely the foregoing examples, but also any examples which fall within the scope of the claims.

Further examples according are listed below as numbered paragraphs:
1. A build material management station, the station comprising:
   a processing unit which comprises a first conduit and at least one pump for pumping build material through the first conduit; and
   at least one external build material storage tank,
   wherein the processing unit further comprises at least a first port and a second port, both ports being located on the exterior of the processing unit such that the external build material storage tank can be connected to the first conduit through the first port and the external build material storage tank can be connected to the first conduit through the second port.
2. The build material management station described in numbered paragraph 1, wherein the processing unit further comprises a connector for connecting the first conduit to a container, the container being suitable for containing at least a mixture of loose and fused build material.
3. The build material management station described in numbered paragraph 1 or 2, wherein the first port is located on a first surface of the processing unit, and the second port is located on a second surface of the processing unit.
4. The build material management station described in numbered paragraph 3, wherein the first surface is arranged orthogonally to the second surface.
5. The build material management station described in any preceding numbered paragraph, wherein the processing unit further comprises at least a third port through which the external build material storage tank can be connected to the first conduit.
6. The build material management station described in any preceding numbered paragraph, wherein the first conduit comprises a hose, the hose being flexible such that it can be fed through the first port or the second port, and wherein the hose comprises a connector for connecting to the external tank.
7. The build material management station described in any of numbered paragraphs 1 to 5, wherein the first conduit is connected to the first port and the second port, the first conduit comprising a valve such that:
   when the valve is in a first position the first port is fluidly connected to the pump via the first conduit and the second port is sealed off from the pump by the valve; and
   when the valve is in a second position the second port is fluidly connected to the pump via the first conduit and the first port is sealed off from the pump by the valve.
8. The build material management station described in any preceding numbered paragraph, wherein the first port can be sealed when not in use.
9. The build material management station described in any preceding numbered paragraph, wherein the external build material storage tank comprises a tank for storing fresh build material, the pump being arranged to pump build material from the external build material storage tank into the processing unit.
10. The build material management station described in any preceding numbered paragraph, wherein the external build material storage tank comprises a tank for storing reclaimed build material, the pump being arranged to pump build material from the processing unit out to the external build material storage tank.
11. The build material management station described in numbered paragraph 8, wherein the pump is further arranged to pump build material from the external build material storage tank into the processing unit.
12. The build material management station described in any preceding numbered paragraph, wherein the processing unit comprises at least one retaining member suitable for retaining the external build material storage tank in a fixed location relative to the processing unit.
13. The build material management station described in any preceding numbered paragraph wherein the processing unit has a substantially rectangular footprint.
14. The build material management station described in any preceding numbered paragraph wherein the external build material storage tank has a substantially rectangular footprint.
15. A three dimensional printing system, comprising:
   a three dimensional printer; and
   a build material management station according to any preceding numbered paragraph.
16. A method of installing a build material management station, the method comprising:
   providing a build material management system according to any of numbered paragraphs 1 to 9;
   connecting the external build material storage tank to the first conduit through the first port; and
   sealing the second port.

1. A build material management station, the station comprising:
a processing unit which comprises a first conduit and at least one pump for pumping build material through the first conduit; and
at least one external build material storage tank,
wherein the processing unit further comprises at least a first port and a second port, both ports being located on the exterior of the processing unit such that the external build material storage tank can be connected to the first conduit through the first port and the external build material storage tank can be connected to the first conduit through the second port.

2. The build material management station of claim 1, wherein the processing unit further comprises a connector for connecting the first conduit to a container, the container being suitable for containing at least a mixture of loose and fused build material.

3. The build material management station of claim 1, wherein the first port is located on a first surface of the processing unit, and the second port is located on a second surface of the processing unit.

4. The build material management station of claim 3, wherein the first surface is arranged orthogonally to the second surface.

5. The build material management station of claim 1, wherein the processing unit further comprises at least a third port through which the external build material storage tank can be connected to the first conduit.

6. The build material management station of claim 1, wherein the first conduit comprises a hose, the hose being flexible such that it can be fed through the first port or the second port, and wherein the hose comprises a connector for connecting to the external tank.

7. The build material management station of claim 1, wherein the first conduit is connected to the first port and the second port, the first conduit comprising a valve such that:
when the valve is in a first position the first port is fluidly connected to the pump via the first conduit and the second port is sealed off from the pump by the valve; and
when the valve is in a second position the second port is fluidly connected to the pump via the first conduit and the first port is sealed off from the pump by the valve.

8. The build material management station of claim 1, wherein the first port can be sealed when not in use.

9. The build material management station of claim 1, wherein the external build material storage tank comprises a tank for storing fresh build material, the pump being arranged to pump build material from the external build material storage tank into the processing unit.

10. The build material management station of claim 1, wherein the external build material storage tank comprises a tank for storing reclaimed build material, the pump being arranged to pump build material from the processing unit out to the external build material storage tank.

11. The build material management station of claim 9, wherein the pump is further arranged to pump build material from the external build material storage tank into the processing unit.

12. The build material management station of claim 1, wherein the processing unit comprises at least one retaining member suitable for retaining the external build material storage tank in a fixed location relative to the processing unit.

13. The build material management station of claim 1, wherein the processing unit has a substantially rectangular footprint.

14. The build material management station of claim 1, wherein the external build material storage tank has a substantially rectangular footprint.

15. A three dimensional printing system, comprising:
a three dimensional printer; and
a build material management station according to claim 1.

16. A method of installing a build material management station, the method comprising:
providing a build material management system according to claim 1;
connecting the external build material storage tank to the first conduit through the first port; and
sealing the second port.
